(19) United States
(12) Patent Application Publication
(10) Pub. No.: US 2009/0166289 A1
(43) Pub. Date: Jul. 2, 2009

(54) Apparatus and Method for Atomizing a Liquid

(76) Inventors: B. James Elliott, Twinsburg, OH (US); Trent Lydic, Lyndhurst, OH (US); Terry Fischer, Mantua, OH (US); Gary Waite, Waterford, PA (US)

Correspondence Address: The Marbury Law Group, PLLC, 11800 SUNRISE VALLEY DRIVE, SUITE 1000, RESTON, VA, 20191, US

(21) Appl. No.: 12/327,573

(22) Filed: Dec. 3, 2008

Related U.S. Application Data
(60) Provisional application No. 60/992,353, filed on Dec. 5, 2007.

(51) Int. Cl. B01F 3/04; B05B 7/02; C02F 3/02; C02F 1/20; C02F 3/16

(52) U.S. Cl. 210/628; 261/78.1; 239/8; 210/150

(57) ABSTRACT

A trumpet-shaped slinger atomizes or aerosolizes liquid by lifting liquid from adjacent the surface of the liquid using helically oriented fins rotated by spinning the slinger on a shaft. The lifted liquid is centrifugally forced over an increasing surface area and ejected from an upper edge as droplets. When used in wastewater aeration, radial fan blades on top of the slinger break up foam and increase air circulation while the increased surface area of the droplets increases diffusion of dissolved gasses from the wastewater.

### RELATED APPLICATIONS

This application claims the benefit of Provisional Application Ser. No. 60/992,353, filed on Dec. 5, 2007, which hereby incorporated by reference in its entirety.

### BACKGROUND

Embodiments disclosed herein are to an apparatus and method for atomizing a liquid and more particularly to an improvement to foam restrictors for wastewater treatment plants.

Wastewater treatment plants, such as those disclosed in U.S. Pat. Nos. 3,400,918, 4,505,813, 5,413,706, 5,484,524, and 5,599,452, as well as U.S. Pat. No. 6,318,705 illustrated in prior art FIG. 1, employ a motor powered aerator to aerate and mix the wastewater. In the illustrated example, a motor 14 rotates an aspirator shaft 12 to spin aspirator 1. In this embodiment, fins 10 on tubes 8 create a low pressure region in wastewater 13 so as to draw outside air through an aperture 15 into the wastewater. As a result of the aeration, foam will often form on the surface and creep up towards the motor unit and its bearings. To address this, the prior art has typically used rotating blades or disks 9 mounted on the aerator shaft 12 above the water line to break up the foam and/or beat the foam down. These are typically referred to as foam restrictors, foam arrestors, foam breaking disks, and foam deflectors. When blades are used, the resulting airflow will often provide some cooling to the motor. While effective at preventing foam from building up in the plant, the prior art devices provide little or no additional benefits to the wastewater treatment process.

### BRIEF SUMMARY

Disclosed embodiments provide foam restriction to a wastewater treatment plant with the additional benefit of removing undesirable dissolved gasses in the wastewater. A uniquely-shaped structure, hereinafter referred to as a “slinger,” lifts water and radially accelerates it over an increasing surface area to atomize or aerosolize the wastewater so as to increase the diffusion rate of dissolved gasses through increased surface area of the water droplets.

In other embodiments, the slinger atomizes or aerosolizes a liquid to assist in various other processes, including but not limited to, liquid vaporization, liquid coating, solution (e.g., brine) concentration, and heat exchange.

### BRIEF DESCRIPTION OF THE DRAWINGS

FIG. 1 illustrates prior art foam deflectors used in wastewater treatment;

FIG. 2 illustrates an embodiment of a slinger used for foam restriction in wastewater treatment;

FIG. 3 illustrates an elevation view of an embodiment of a slinger; and

FIG. 4 illustrates an isometric view of an embodiment of a slinger.

### DETAILED DESCRIPTION

Wastewater treatment plants typically have excess ammonia, nitrogen, and some other gasses in solution in the aerobic treatment chamber. It is advantageous to remove as much of these gasses from this water as possible. By atomizing or aerosolizing a volume of water, and therefore increasing the surface area of the volume of water, the diffusion rate of dissolved gasses can be increased.

Embodiments of a slinger atomize or aerosolize a volume of water and further increase airflow in the treatment chamber. In this manner, droplets are exposed to an increased volume of atmospheric gasses. By simultaneously increasing the contact time and volume of atmospheric gasses, disclosed embodiments will, through the process of diffusion, strip the gasses that are desirable to have removed from the wastewater in the treatment plant. The exact amounts of gasses stripped by this method are based on a very complex matrix of variables, including, but not limited to, the exact geometry of the slinger itself.

As used herein, the term “trumpet-shaped” refers to an axially-symmetric shape similar to the bell of a trumpet in that it has a circular cross-section that flairs or expands increasingly along its length. The shape can be described mathematically by a conic section, such as a concave arc or curve, that is rotated about an axis.

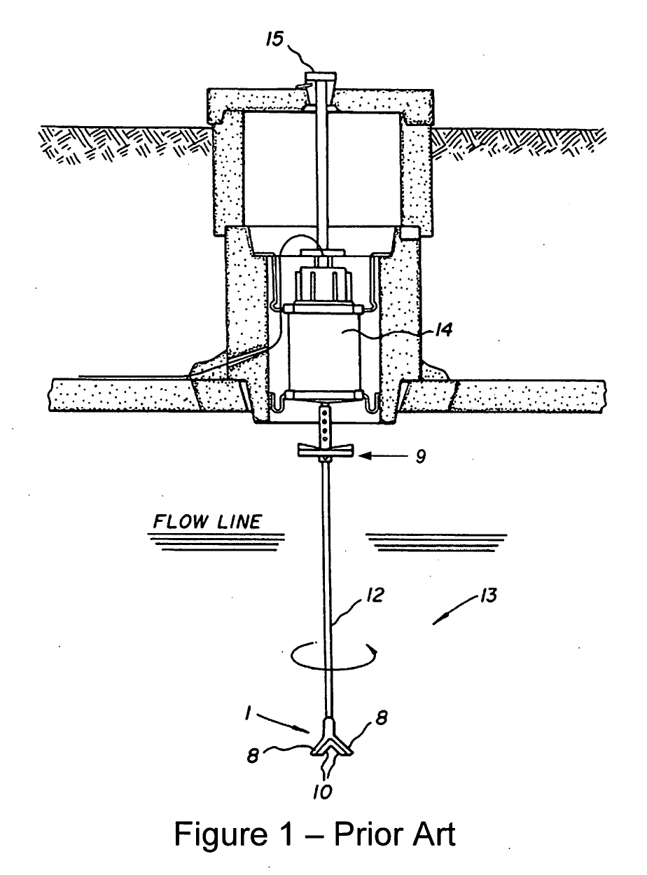

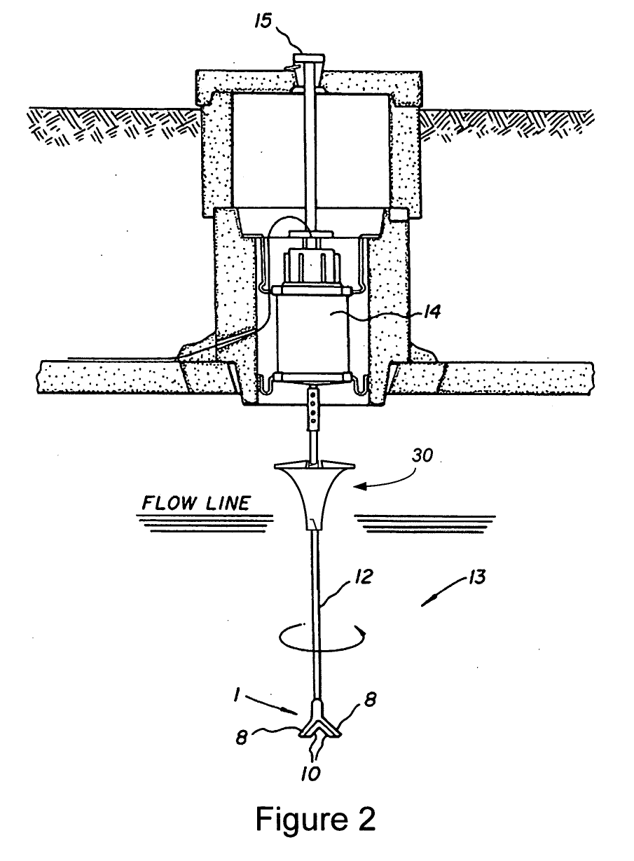

As illustrated in FIG. 2, in which carried-over elements retain the same reference numerals discussed with respect to FIG. 1, a foam breaking disk or blade as used by the prior art is replaced with a slinger 30 that is mounted on the aspirator shaft 12 with its lower end engaging the water line of the treatment chamber. Mounted in this position, longitudinally-extending fins or strakes on the lower end of the slinger 30 will induce a flow of water upward along the body of the spinning slinger 30 which throws droplets radially off of the top edge. Fan blades mounted on top of the slinger 30 blows air and droplets horizontally outward and breaks or beats down any accumulated foam. Evaporation of the droplets and circulation from the fan blades provide cooling to the motor 14. While it is possible to form slinger 30 integrally with aspirator shaft 12, the slinger 30 is preferably a separate device formed of any suitable corrosion-resistant material, including but not limited to, polyethylene, polypropylene, phenolic resin, polyvinyl chloride (PVC), various other plastics, metals, ceramics, and combinations thereof. The slinger 30 can be secured to the shaft in any suitable manner, such as by a set screw or frictional wedge.

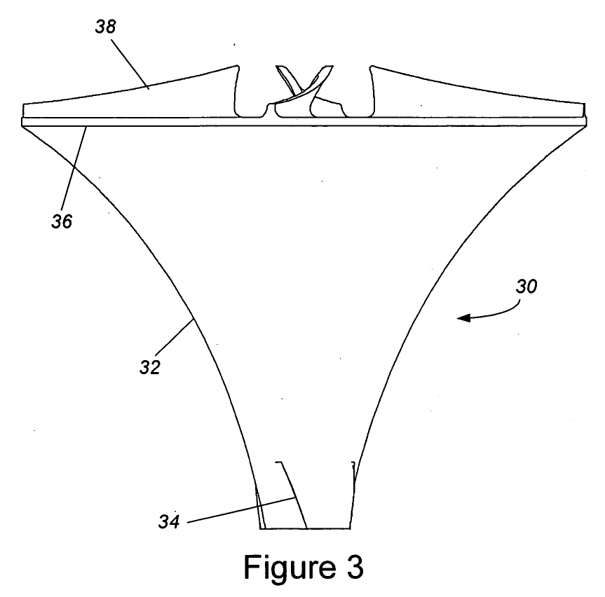

As illustrated in FIG. 3, the slinger 30 comprises a substantially trumpet bell-shaped (hereinafter “trumpet-shaped”) body 32 and includes a plurality of longitudinal fins or strakes 34 at a lower end so as to be orientated below and helically perpendicular to a liquid level when the slinger 30 is mounted on a rotating shaft. The strakes 34 are moved through the liquid (e.g., wastewater) by the spinning a shaft (e.g., an aerator or aspirator shaft) at a velocity sufficient to cause cavitation. The cavitation prevents the formation of a liquid vortex at the convergence point of the slinger 30 and the liquid. At the same time as the trailing edge of the strakes 34 produce the cavitation, the leading edge provides lift to induce the flow of liquid up the surface of the geometry of the body 32 of the slinger 30. The trumpet-shaped body 32 of the slinger 30 is formed as a rotated body having a diameter that smoothly increases from a first lower diameter to a second upper diameter at a rate greater than linear, such as provided by a concave radius or a parabola.

In one exemplary embodiment, the slinger 30 is formed of PVC and has a 0.635 diameter axial hole for attachment to an aspirator shaft for wastewater treatment. The longitudinally-extending fins or strakes 34 are helical about the axis of the slinger at an angle of approximately 21 degrees relative to the axis, which is approximately optimized for the RPM used and viscosity of water. A bottom edge of the curve of body 32 is has a tangent at about 10-12 degrees relative to the axis of rotation and the top edge of the curve has a tangent at about 55 degrees relative to the axis. Wastewater is atomized by rotating the slinger 30 at 1750 RPM with a body 32 having dimensions of a 1.125 inch bottom diameter, 8 inch top diameter, and approximately 6 inch height. A formula approximately describing the curve is:

X²+Y²+(3.723*X)+(4.872*Y)=11.5405 (1)

although this is not meant as a limitation and is provided as but one example only.

As this liquid is directed upward and outward along the increasing surface area of the slinger 30 by centrifugal force, it is accelerated and thinned sufficiently so that when the liquid reaches the edge 36 of the upper diameter of the slinger 30, it has sufficient velocity to depart from the surface of the slinger 30 as atomized or aerosolized droplets. The droplets provide an increased surface area/gas ratio. In a preferred embodiment, radial fan blades 38 are provided on the upper surface of the slinger 30 to increase the gas/droplet mixing. In the wastewater environment, the fan blades blow air radially to beat down foam and draw an increased volume of atmospheric gasses (i.e., air) into contact with the droplets. The surface area/air ratio is increased sufficiently to promote the diffusion of dissolved gasses in the droplets so as to remove undesirable dissolved gasses from (i.e., de-gas) the wastewater. The removed gases can then be vented from the system into the atmosphere.

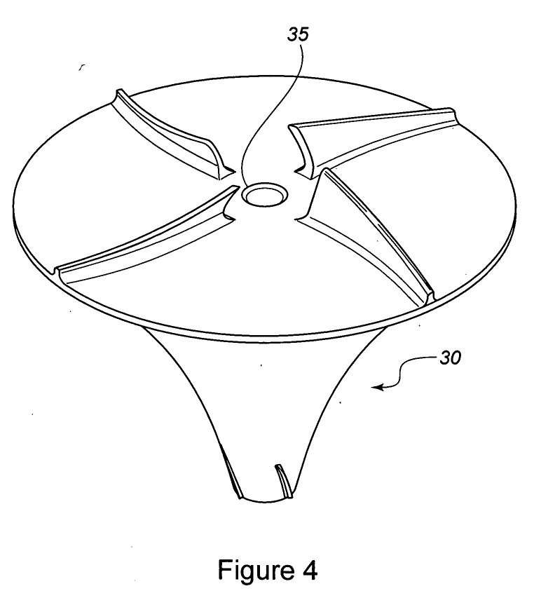

As illustrated in FIG. 4, the slinger preferably includes an axial hole 35 for mounting the slinger 30 on a rotating shaft such as an aspirator shaft.

In addition to the previously-discussed improvements in de-gassing of wastewater and cooling of the drive motor, the use of the slinger unexpectedly improves the foam breaking capabilities to such an extent that aeration levels can be increased without causing problems due to increased foam production. The slinger can also allow energy savings by operating at more energy-efficient rotational speeds at which prior art foam arresting discs would be ineffective, and can be tuned to operate at the most energy-efficient rotational speed of the motor.

The slinger is not limited to use in wastewater foam restrictor applications. Embodiments have additional utility for: generally de-gassing water of carbon dioxide, hydrogen sulfide, excess nitrogen, ammonia, chlorine, and other dissolved gasses; vaporization of water for various uses, such as humidification or brine concentration; vaporization of other liquids; and stripping dissolved solids from solution via evaporative deposition through the process of diffusion, such as found in the reclamation of salts from brine solutions. In such applications, use of the radial fan blades is optional.

The principles of the disclosed embodiments can also be combined with existing technologies for: formation and delivery of metered amounts of various vaporized liquids; aerobic treatment of water in conjunction with ultraviolet light for the purpose of purification; fluid transfer and collections by condensation; evaporative cooling of other devices (cooling towers); and effecting a convective air current for use in HVAC applications.

In one embodiment, an apparatus for atomizing a liquid comprises a trumpet-shaped body having an axis, a bottom with a first diameter, a top with a second diameter larger than the first diameter, and a surface that extends between the bottom and the top and that increases smoothly in diameter at a rate greater than linear. A plurality of longitudinally-extending strakes are mounted adjacent the bottom of the body, so that when rotated about the axis at a sufficient speed, such as with a shaft through an axial hole in the body, the liquid is lifted, moved along the increasing surface area of the body and broken into droplets. Variations on this embodiment include those wherein the longitudinally-extending strakes are helical about the axis. The embodiment can also include a plurality of substantially-radial, and preferably helical, fan blades extending from the top of the body.

Another embodiment is to a foam arrestor for use in wastewater aeration that comprises a trumpet-shaped body comprising an axis, a bottom with a first diameter, a top with a second diameter larger than the first diameter, and a surface that extends between the bottom and the top and that increases smoothly in diameter at a rate greater than linear, a plurality of longitudinally-extending strakes adjacent the bottom of the body, and an axial hole dimensioned for mounting the body on an aspirator shaft. When rotated about the axis at a sufficient speed by an aspirator shaft, the wastewater is lifted, moved along the increasing surface area of the body and broken into droplets. Variations on this embodiment include those wherein the longitudinally-extending strakes are helical about the axis. The embodiment can also include a plurality of substantially-radial, and preferably helical, fan blades extending from the top of the body.

A further embodiment is to a method for atomizing a liquid. This method comprises positioning a trumpet-shaped body in a substantially vertical position with its lower end engaging the surface of the liquid, rotating the trumpet shaped body about a central axis, lifting liquid adjacent the surface with a plurality of longitudinally-extending strakes adjacent the bottom of the trumpet-shaped body, centrifugally forcing the liquid over an increasing surface area of the trumpet-shaped body to form a thin film of liquid, and breaking the thin film of liquid into droplets as they are radially thrown from an upper end of the trumpet shaped body. In a variation of this method, the droplets are blown radially outward with a plurality of substantially-radial, and preferably helical, fan blades extending from the top of the trumpet-shaped body. In another variation, the longitudinally-extending strakes are positioned helically about the axis.

In one embodiment of the method, the liquid is wastewater being aerated, and the process further comprises breaking up foam on the surface of the wastewater with a plurality of substantially-radial, and preferably helical, fan blades extending from the top of the trumpet-shaped body. The method can further comprise the removing of dissolved gasses from the wastewater by the circulation of atmospheric air to allow diffusion of the dissolved gasses from the droplets of wastewater.

An apparatus and method for atomizing a liquid, as well as the application of the apparatus and method to wastewater treatment, have been described. It will be understood by those skilled in the art that the present invention may be embodied in other specific forms without departing from the scope of the claims, and that the examples and embodiments described herein are in all respects illustrative and not restrictive. Those skilled in the art will recognize that other embodiments using the concepts described herein are also possible. Further, any reference to claim elements in the singular, such as using the articles “a,” “an,” or “the,” is not to be construed as limiting the element to the singular.

What is claimed is:

1. An apparatus for atomizing a liquid, comprising:
a trumpet-shaped body comprising an axis, a bottom with a first diameter, a top with a second diameter larger than the first diameter, and a surface that extends between the bottom and the top and that increases smoothly in diameter at a rate greater than linear; and
a plurality of longitudinally-extending strakes adjacent the bottom of the body.

2. The apparatus of claim 1, further comprising means to rotate the body about the axis.

3. The apparatus of claim 1, further comprising an axial hole dimensioned for mounting the body on a shaft.

4. The apparatus of claim 1, further comprising a plurality of substantially-radial fan blades extending from the top of the body.

5. The apparatus of claim 1, wherein the longitudinally-extending strakes are helical about the axis.

6. The apparatus of claim 4, wherein the substantially-radial fan blades extending from the top of the body are helical about the axis.

7. A foam arrestor for use in wastewater aeration, comprising:
a trumpet-shaped body comprising an axis, a bottom with a first diameter, a top with a second diameter larger than the first diameter, and a surface that extends between the bottom and the top and that increases smoothly in diameter at a rate greater than linear;
a plurality of longitudinally-extending strakes adjacent the bottom of the body;
an axial hole dimensioned for mounting the body on an aspirator shaft.

8. The foam arrestor of claim 7, further comprising a plurality of substantially-radial fan blades extending from the top of the body.

9. The foam arrestor of claim 8, wherein the substantially-radial fan blades are helical about the axis.

10. The foam arrestor of claim 7, wherein the longitudinally-extending strakes are helical about the axis.

11. A method for atomizing a liquid, comprising:
positioning a trumpet-shaped body in a substantially vertical position with its lower end engaging the surface of the liquid;
rotating the trumpet shaped body about a central axis;
lifting liquid adjacent the surface with a plurality of longitudinally-extending strakes adjacent the bottom of the trumpet-shaped body;
centrifugally forcing the liquid over an increasing surface area of the trumpet-shaped body to form a thin film of liquid; and
breaking the thin film of liquid into droplets as they are radially thrown from an upper end of the trumpet shaped body.

12. The method of claim 11, further comprising
blowing the droplets radially outward with a plurality of substantially-radial fan blades extending from the top of the trumpet-shaped body.

13. The method of claim 11, wherein the longitudinally-extending strakes are positioned helically about the axis.

14. The method of claim 11, wherein the liquid is wastewater being aerated, and further comprising:
breaking up foam on the surface of the wastewater with a plurality of helical fan blades extending from the top of the trumpet-shaped body.

15. The method of claim 14, further comprising removing dissolved gasses from the wastewater by circulating atmospheric air to allow diffusion of the dissolved gasses from the droplets of wastewater.

16. The method of claim 11, further comprising
blowing the droplets radially outward with a plurality of helical fan blades extending from the top of the trumpet-shaped body.
